(19) United States
(12) Patent Application Publication
(10) Pub. No.: US 2008/0209007 A1
(43) Pub. Date: Aug. 28, 2008

(54) Methods, systems, and computer program products for accessing data associated with a plurality of similarly structured distributed databases

(75) Inventors: David W. Gurecki, Durham, NC (US); David Michael Sprague, Raleigh, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/899,628

(22) Filed: Sep. 6, 2007

Related U.S. Application Data
(60) Provisional application No. 60/903,809, filed on Feb. 27, 2007.

(51) Int. Cl. G06F 17/30; G06F 15/173

(52) U.S. Cl. 709/218; 707/10; 707/E17.032

(57) ABSTRACT

Methods, systems, and computer program products for accessing data associated with a plurality of similarly structured distributed databases are disclosed. According to one method, a first value of a data element associated with a first distributed database is received from the first distributed database. A second value of a data element associated with a second distributed database is received from the second distributed database. The first and second values of the data element are included in a third merged database. The first and second values of the data element in the third merged database are accessed.

### RELATED APPLICATIONS

This application claims the benefit of U.S. Provisional Patent Application Ser. No. 60/903,809, filed Feb. 27, 2007; the disclosure of which is incorporated herein by reference in its entirety.

### TECHNICAL FIELD

The subject matter described herein relates to distributed databases. More particularly, the subject matter described herein relates to methods, systems, and computer program products accessing data associated with a plurality of similarly structured distributed databases.

### BACKGROUND

Databases are one of the most widely used applications found in computing. A database is a collection of related information about a subject organized in a useful manner that provides a base for procedures such as retrieving information, drawing conclusions, and making decisions. A distributed database is a variation in which information is distributed or spread over a number of sites which are connected through a communications network.

In a distributed database, data is exchanged between the databases located at different sites. For example, it may be necessary for a database residing at a server or node of a network to share its data with another server or node in a higher logical tier of the network. Several techniques, such as data replication, have been developed for making data available at one location (i.e., a source location) for use at other locations (i.e., destination locations).

Data replication is a process by which data residing in data tables at a source location are made available for use at destination locations. In particular, it is the process of keeping the destination data, which resides in destination data tables, synchronized with the source data contained in the source tables. One problem with data replication is that identical copies of data are provided to each node in the network. Such data distribution requirements may result in data being communicated that is not needed at its destination. For example, in hierarchical networks, it may not be necessary for data originating at one level to be made available to other nodes at the same level or at lower levels in the hierarchy.

Another problem in data replication is that the distribution processes are often designed for use by specific applications and for specific data types. Thus, data replication designs are not easily reusable when being applied to new applications or new data types. It would be beneficial to provide data distribution processes and systems capable of being generically applied to many applications and data types.

Accordingly, in view of the above needs with regard to distributed databases, it is desirable to provide improved processes and systems for distributing data among distributed databases.

### SUMMARY

The subject matter described herein includes methods, systems, and computer program products for accessing data associated with a plurality of similarly structured distributed databases. According to one aspect, a method according to the subject matter described herein includes receiving from the first distributed database a first value of a data element associated with a first distributed database. Further, the method may include receiving, from a second distributed database, a second value of a data element associated with the second distributed database. The first and second values of the data element are included in a third merged database. The first and second values of the data element in the third merged database are accessed.

The subject matter described herein for accessing data associated with a plurality of similarly structured distributed databases may be implemented using a computer program product comprising computer executable instructions embodied in a computer readable medium. Exemplary computer readable media suitable for implementing the subject matter described herein include disk memory devices, programmable logic devices, application specific integrated circuits, and downloadable electrical signals. In addition, a computer readable medium that implements the subject matter described herein may be located on a single device or computing platform distributed across multiple physical devices and/or computing platforms.

### BRIEF DESCRIPTION OF THE DRAWINGS

Exemplary embodiments of the subject matter will now be explained with reference to the accompanying drawings, of which:

FIG. 1 is a schematic diagram of an exemplary system for accessing data associated with a plurality of similarly structured distributed databases according to an embodiment of the subject matter described herein;

FIG. 2 is a schematic diagram of parent and child servers configured for data merging in accordance with the subject matter described herein;

FIG. 3 is a flow chart of an exemplary process for data merging between servers shown in FIG. 2 in accordance with the subject matter described herein;

FIG. 4 is a schematic diagram of active and standby servers configured for data merging in accordance with the subject matter described herein; and

FIG. 5 is a flow chart of an exemplary data merging process interaction between active and standby servers shown in FIG. 4 according to an embodiment of the subject matter described herein.

### DETAILED DESCRIPTION

Systems, methods, and computer program products disclosed herein provide for accessing data associated with a plurality of similarly structured distributed databases. Particularly, systems, methods, and computer program products disclosed herein relate to data merging. Data merging is a process of collecting records from databases on nodes or servers in a lower tier of a topology and merging the records together into a single database on a node or server in a higher tier. One objective of this process is to efficiently deliver data from a deployed network of servers to one or more tiers of administrative systems or servers. Exemplary data for delivery includes operational statistics, current status, and event history. The generic implementation of this process at the database level provides a reusable framework for delivering this data to administrative systems, promoting greater simplicity, and rapid development of new applications. Further, this process can be generically applied to many different data types.

Database merging is similar to database replication, a process by which an identical copy of data within a database is maintained across separate database servers in a network. One primary difference is that with data merging, the database may not be identical across all servers. For example, in data merging, a server in a particular tier may not see or receive data from neighboring servers in the same tier. Further, in data merging, each record in a merged database contains an identification of the source node from which it was collected. This process ensures that records from separate nodes remain distinct in the merged database. In this way, the merged database contains the superset of other databases rather than an identical copy of a single database.

A goal of database replication/synchronization is to make all copies of the database that are distributed throughout the system same. This typically requires audit and reconciliation processes for ensuring system-wide uniformity across all of the distributed databases. A problem addressed by the subject matter described herein relates not to database replication/synchronization, but rather to the collection and manipulation of data that is distributed over multiple, identically structured, databases in a network.

Without the data merging processes disclosed herein, multiple distributed databases would have to be accessed/queried individually to obtain a system-wide data view. This would require a centralized access function that would have to have knowledge of each of the distributed databases, and that would have to generate multiple queries, and reconcile the corresponding multiple responses. Each time that a system-wide “view” of data was desired by an operator, each of the distributed databases would have to be queried, so as to obtain the most current data values (e.g., alarms, peg counts, etc.).

Systems and methods disclosed herein are capable of generating a real-time/near real-time merged or “superset” database that includes data from each of the distributed databases in the system. While the database structure/schema associated with each of the distributed databases in the system is uniform, the contents of each database in the system may differ. The subject matter described herein provides a generic solution to this data merging problem.

In one exemplary embodiment of the subject matter described herein, an operations, administration, and maintenance (OAM) system in an IP multimedia subsystem (IMS) network includes a network-level OAM server which communicates with a plurality of system-level OAM servers/functions, where each system-level OAM function supports one or more message processor functions (e.g., S-CSCF, I-CSCF, P-CSCF, HSS, etc.). Each system level OAM is adapted to collect measurements and alarms (MEAL) data for the supported message processor functions and to store the collected data in one or tables that comprise a system-level MEAL database. Associated with the one or more tables is an intrinsic property or attribute known as a “merged” attribute. The merged attribute may either be set to “True” or “False”. If the merged attribute is set to True, then the associated system-level OAM is adapted to automatically communicate any changes in the MEAL table data to the network-level. In another mode of operation, if the merged attribute is set to True, then the associated system-level OAM is adapted to automatically communicate all MEAL table data at periodic time intervals.

In either case, MEAL data is automatically communicated from the lower hierarchy level (e.g., system OAM) to the next highest hierarchy level (e.g., network OAM). The network OAM function that receives the MEAL data that is sent by the various system-level OAM functions is adapted to insert the received MEAL data into a “merged” MEAL database that essentially contains a superset of all of the MEAL data from all of the MEAL databases in the system that reside at hierarchy levels below the network level. In this respect, the subject matter described herein can be applied generically to hierarchical network topologies of any size (i.e., not just the 2 or 3 layer hierarchy discussed here). It will be appreciated that the “merged” superset MEAL database and all of the system-level MEAL databases share the same structure/schema.

One advantage of this data merging architecture is that system-wide status may be obtained by a network operator with a single query of the network-level “merged” superset MEAL database (as opposed to requiring the network operator to query each message processor/function individually, receiving and compiling all of the responses, and presenting the compiled summary to the user . . . only to have to repeat the entire multi-query process each time the user requires an “updated” view).

It will be appreciated that another advantage of the subject matter described herein is that each time that a new message processor/function is added to the network, the message processor simply reports its MEAL data to the serving system-level OAM function, which places the data in a MEAL table with the “merged” attribute set True. The system OAM function then automatically reports the changed MEAL data (or periodically reports all the MEAL data) to the network-level “merged” superset MEAL DB. (As opposed to the network-level OAM being required to “know” that a new message processor has been added, and subsequently modifying its multi-query script/routine to include the new message processor. This difference is similar in nature to “plug-and-play” versus manual configure type operation).

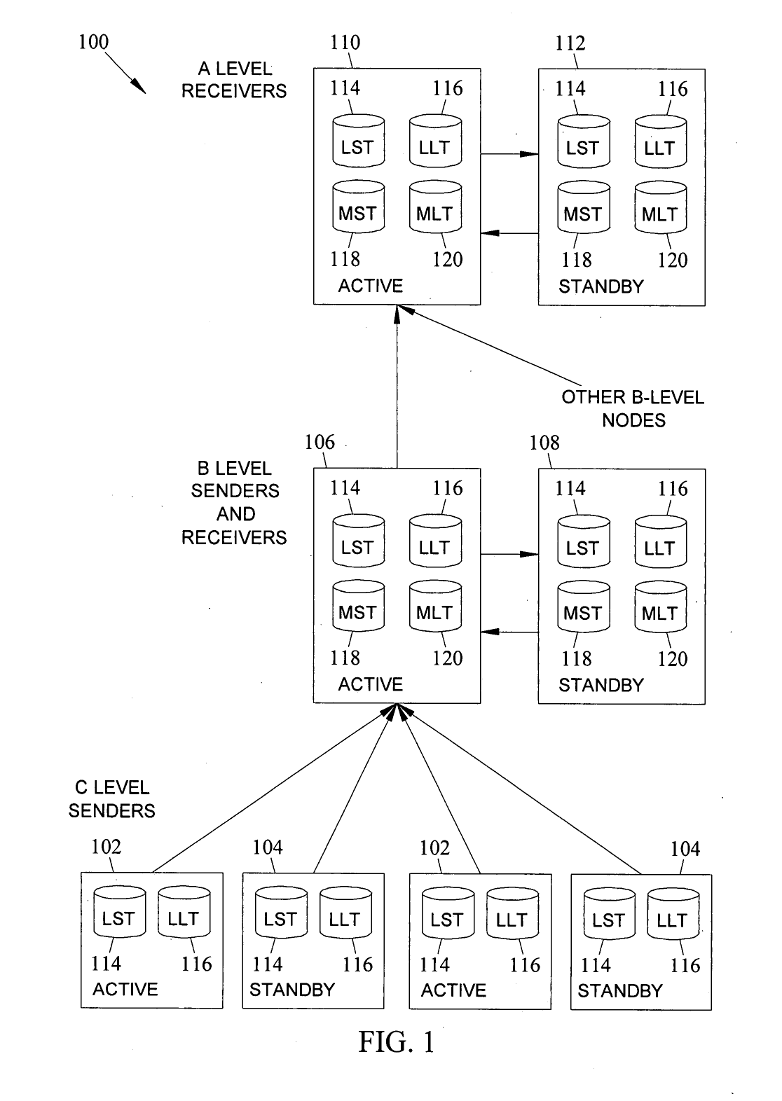

A system for accessing data associated with a plurality of similarly structured distributed databases may be implemented as hardware, software, and/or firmware components executing on one or more components of a network. FIG. 1 illustrates a schematic diagram of an exemplary system generally designated 100 for accessing data associated with a plurality of similarly structured distributed databases according to an embodiment of the subject matter described herein. Referring to FIG. 1, system 100 may include a three-tiered network topology supported by data merging. However, a system in accordance with the subject matter described herein may include any number of network topology tiers. The tiers of system 100 are referred to as topology levels A, B, and C, where A is at the highest topology level, B is at the middle topology level, and C is at the lowest topology level. Each topology level may include one or more servers. Although for the examples described herein servers are described as being the component of a network including similarly structured distributed databases, the examples described herein may be applied to any type of suitable network node including a distributed database.

Topology level C may include servers running specific applications in a network. For example, the servers may include applications for monitoring signaling links in a telecommunications network. System 100 includes mated pairs of servers, where each pair includes an active server 102 and a standby server 104 in topology level C. The pairs are mated in an active-standby configuration for one-to-one redundancy. Servers 102 and 104 may include current status and log (or historical) event information that may be of interest to administrators accessing servers or systems at higher topology levels. Although servers 102 and 104 are illustrated as mated pairs of servers, topology level C may also include more than two mated servers and/or non-mated, independent servers.

Topology levels A and B represent administrative systems. The tiers of topology levels A and B may have pairs of servers which are mated in an active-standby configuration. For example, topology level B may include active server 106 and standby server 108. Topology level A may include active server 110 and standby server 112. Although the servers at topology levels A and B are illustrated as mated pairs of servers, these topology levels may also include more than two mated servers and/or non-mated, independent servers.

Topology level A is the highest tier in the network. Topology level B includes administrative systems which govern a smaller subset of servers. Servers at lower levels may be grouped together by geographic region, common functionality, or another suitable basis.

Data merging in accordance with the subject matter described herein can also be implemented in a scaled-down or scaled-up version of the topology shown in FIG. 1. For example, a scaled-down system in which the subject matter described herein may be implemented may include only one tier of administrative servers and only one tier of application servers. Similarly, a scaled-up system in which the subject matter described herein may be implemented may include more than three hierarchical levels.

In the illustrated example, the servers in topology tiers A, B and C may include databases for storing local state tables (LSTs) 114 and local log tables (LLTs) 116. The databases may be similarly structured distributed databases. Local data stored in local state tables 114 and local log tables 116 may be directly manipulated by applications residing on the same server. The applications may modify the contents of the local data as appropriate to their respective operations. The data stored in tables as described herein may comprise one or more data elements, where each data element can have one of a plurality of different values as can be appreciated by those of skill in the art.

As used herein, the term “state tables” refers to a group of tables within a database which contain stateful data. Stateful data refers to data which reflects the current state of a system. This data may contain information that generally describes a condition, parameter, or the like about the system at the present moment. Stateful data may be updated frequently as system state changes. The current value of this data may be significant to system administrators, but the historical changes of this data may be less relevant. Examples of stateful data include a list of currently asserted alarms, values of system measurements, status of connections to other servers, and application status.

State tables may be defined by applications with any number of fields and with few minimum requirements. Each table may include a source server field as part of a primary key. The primary key may be required to ensure that records stored on administrative topology levels can uniquely identify the server from which the records originated, and that records from one server cannot overwrite records from another server.

As used herein, the term “log tables” refers to a group of tables within a database which contains log data. Log Data refers to data which describes events occurring at specific times. Each event is associated with a timestamp describing when it occurred. Further, new entries to the log table may only be appended to the end of the event log. Examples of log data include warnings generated by applications, events indicating connection loss or changes in application state, and sent and received messages.

Log tables may be defined by applications with any number of fields. Each table may include a source server field as part of a primary key. Further, log tables may have a restriction that they must include a timestamp for each record. New entries may only be appended to the end of the table. Thus, inserting a record with an older timestamp may be prohibited. Applications may define any additional fields or keys as needed.

Administrative level servers (e.g., the servers of topology levels A and B) can include merge state and log tables corresponding to local state and log tables. For example, the merge state and log tables may be similarly structured to local state and log tables of lower level servers. As stated above, the data contained in local tables may be directly manipulated by applications on the respective servers. Accordingly, applications residing on these servers may modify the contents of local tables as appropriate to their operations. The data contained in merge tables has an identical schema definition as the data in the local tables. However, the data in the merge tables is modified exclusively by a data merging process to store records and data received from other servers. Applications may retrieve or read data in the merge tables, but they may not modify this data. Thus, the data in the merge tables may be designated as read-only data.

Servers in the A and B levels of the topology can have an identical database schema. That is, all of these servers may have local and merge tables. The C level servers do not receive records from any other servers in the network, therefore the C level servers only include local tables. The A Level and B Level servers receive records from their child servers, and these records are stored in their merge state tables (MSTs) and merge log tables (MLTs) 118 and 120, respectively. As set forth above, these servers are running their own applications which may generate records into local state and log tables. A data merging process in accordance with the subject matter described herein can merge records from the local tables of a server into the merge tables of the server. Further, local records from a mate standby server in a pair can be combined into the merge tables of an active server. As a result of these processes, administrators can use a display of a server to view locally-generated status and events merged together with data from tables of servers in lower tiers.

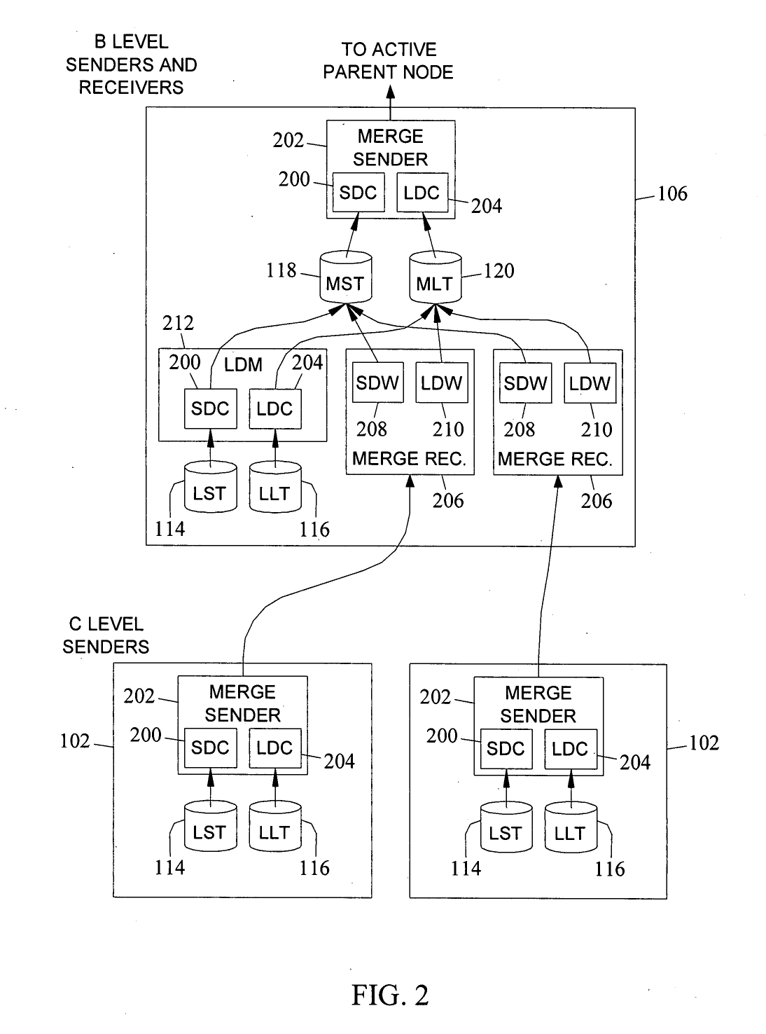

FIG. 2 is a schematic diagram of parent and child servers configured for data merging in accordance with the subject matter described herein. Particularly, the diagram shows exemplary internal components for implementing the data merging functionality between B level server 106 and C level servers 102 in the topology. B level server 106 is also connected to an A level server (not shown). In this example, B level server 106 does not have a standby mate. Servers 102 may include distributed databases comprising local state and local log tables 114 and 116.

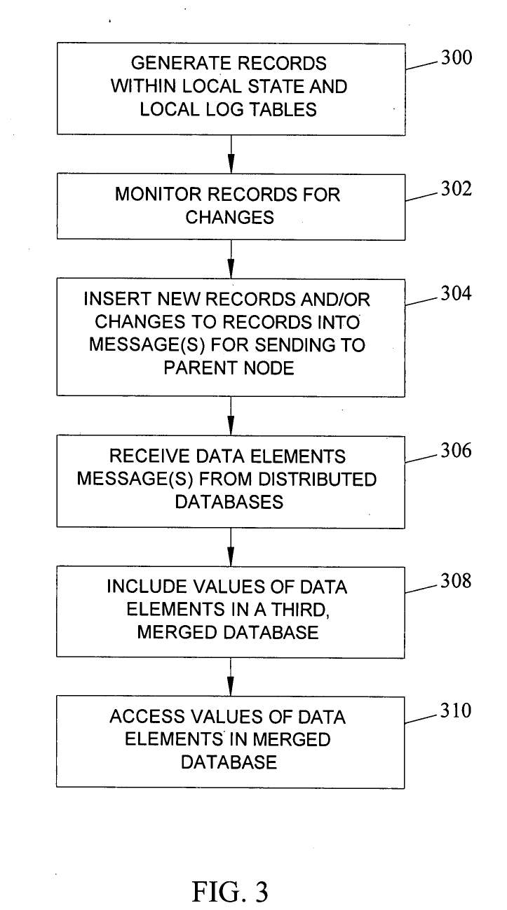

FIG. 3 is a flow chart of an exemplary process for data merging between servers 102 and 106 shown in FIG. 2 in accordance with the subject matter described herein. Referring to FIGS. 2 and 3, the data merging process begins at the C level servers 102. Applications running on servers 102 generate records within local state tables 114 and local log tables 116 (block 300).

Tables 114 and 116 can be monitored by the data merging process to detect any changes to the records (block 302). For example, a stateful data collector 122 may maintain a persistent copy of each table in memory to serve as a basis for comparison. A stateful data collector (SDC) 200 residing in servers 102 and 106 may periodically compare the contents of corresponding local state tables 114 with the in-memory copy and may convert any differences into message form and enqueue the messages with a merge sender function 202. A log data collector (LDC) 204 may maintain a cursor in each log table 116 and periodically scan for records beyond the cursor. After a scan, the cursor may be moved to be placed after the last record scanned. In one implementation, since new records can only be inserted at the end of the table, this process will find new records very efficiently.

New records or changes to records detected by the scanning may be serialized into messages to be sent to a parent server (block 304). For example, merge sender function 202 may insert new records and/or changed records into one or more messages for sending to a parent server. Merge sender function 202 of C level servers 102 may send the messages to parent server 106. For example, the message may contain one or more values of a data element of one or more of tables 114 and 116 along with an identifier that uniquely identifies the server originating the value.

Messages containing values of table data elements may be communicated to a higher tier server by an instance of a merge sender object. For example, each C level server 102 may contain merge sender function 202 configured to implement a messaging protocol for communicating with a merge receiver function 206 on the parent B level server 106. When new table changes or new table entries are ready to be sent, merge sender function 202 may combine the available updates together into a single message and send it to merge receiver function 206 of the parent server. Each message may contain a sequence number.

In block 306, merge receiver functions 206 are configured to receive data elements in the messages from the distributed databases of child servers 102. Merge receiver function 206 may be configured with the messaging protocol to communicate acknowledgements to the originating merge sender function 202 for verifying that the message was received. A configurable sliding window may be used to increase messaging efficiency. For example, the size of the window may define the maximum number of packets that a sender can send to a receiver before receiving an acknowledgement. The window may advance or slide to allow more packets to be sent as acknowledgements are received by the sender.

Although server 106 is shown in FIG. 2 as including two merge receiver functions, in one alternate implementation, servers may include any number of merge receiver functions. Each merge receiver function may be operable to receive and manage messages from one or more merge sender functions. For example, a single merge receiver function may be operable to receive and manage message from multiple distributed databases.

Merge receiver functions 206 may implement the receiver side of the messaging protocol, which primarily acknowledges update messages when they are received. A separate instance of a merge receiver object may be created for each child server that a respective merge receiver function knows about in the topology. Each merge receiver 206 may process incoming messages as soon as they arrive and updates may be applied to the database inline with message processing. In one embodiment, only one merge receiver object runs at a time, and database locks may be acquired before writing to the database to avoid possible contention from other processes.

In block 308, the values of data elements are included in a third merged database of server 106. For example, merge receivers 206 may include stateful data writer function (SDW) 208 and log data write function (LDW) 210 configured to write the received data elements to merge state and log tables 118 and 120, respectively. The received messages containing the data elements may be unserialized and converted back into database updates by stateful data and log data writer functions 208 and 210. These updates are applied to merge state and merge log tables 118 and 120. Stateful data updates may include insert, modify, or delete operations on any record in state tables 118. Log data updates may include insert operations which will be appended to the end of log tables 120.

In each B level server, a local database merge function 212 may handle the task of merging updates from the local state and log tables 200 and 204 of server 106 into merge state and merge log tables 118 and 120, respectively. Function 212 may implement stateful and log data collectors 200 and 204 of server 106 similar to merge sender function 202. However, instead of bundling updates into message form, they are applied directly into merge tables 118 and 120 on the same server. This task is performed periodically and asynchronously with update operations performed by merge receiver functions 206 such that only one object is writing to the merge tables 118 and 120 at any time.

In block 310, the values of data elements in tables 118 and/or tables 120 of server's 106 merged database are accessed. The values can be accessed for use in applications running on server 106 and/or for communication to another server.

B level server 106 may include merge sender function 202 configured to send updates to the active parent in the A level. Function 202 may perform functions similar to the merge sender function 202 in C level server 102. At least one difference is that merge sender function 202 monitors merge tables 118 and 120 rather than local tables. All updates applied by merge receiver functions 206 and local database merge function 212 may be picked up by merge sender function 202. In this way, the A level server will receive all updates originated on servers below B level server 106 in the hierarchy, as well as updates originated on B level server 106.

The functionality of the A level server is similar to that of B level server 106. At least one difference is that A level servers do not include merge sender functions for forwarding updates to a parent, since they are by definition at the top of the hierarchy. Otherwise, for example, A level servers have all the same components as B level servers: merge receiver functions to implement protocol semantics with B level merge sender functions, stateful and log data writer functions to apply updates, and a local database merge function to apply updates from local tables into merge tables.

As stated above, servers may be mated in an active/standby pair arrangement for providing one-to-one redundancy. In this arrangement, if the active server fails, the standby server in the pair must then assume the role of the newly active server. Therefore, the newly active server must be able to begin receiving updates from child servers for both stateful and log data. Servers may include a merge table function operable to maintain an up-to-date copy of the stateful and log table contents from each of its child servers in the hierarchy. When a failover event occurs, the standby server also needs to have all the contents of these tables in order to properly handle subsequent update messages. This can be accomplished by at least one of two ways: (1) the active server can forward all updates to the standby server as the updates are received; or (2) the standby server can request the full table contents from all its child servers when it becomes active. In one embodiment of the subject matter described herein, data merging process utilizes the first alternative for log tables and the second alternative for stateful tables.

State tables are typically updated very frequently, but they are expected to be relatively limited in size because they represent current server's status information. If a backup copy was to be maintained on a standby server, the high frequency of changes would lead to excessive messaging to and processing time on the standby server. Since historical updates are typically not important and the total quantity of data is relatively small, it may be more practical to have child servers send their full table contents to a newly active server after a failover event. This refreshes the newly active server to have the latest table contents from each child server fairly quickly, after which it is ready to receive update messages.

Log tables typically contain a much larger quantity of data than state tables. The frequency of updates to log tables can be expected to be much lower than state tables. Thus, with regard to log tables, the messaging cost to keep a backup copy on the standby server up-to-date may often be justified given the less frequent updates. This messaging is much cheaper than having each child send its entire table contents after a failover.

Thus, in accordance with one embodiment of the subject matter described herein, the primary role of a standby server will be to receive updates for log data tables but not stateful data tables while the standby server is in standby mode. Additionally, the standby server may be operable to generate its own local records into local stateful and log data tables. Since system administrators will interact with the active server in the pair, these records may be forwarded to the active server in order to be accessible to the administrators. This is a secondary task of the standby server.

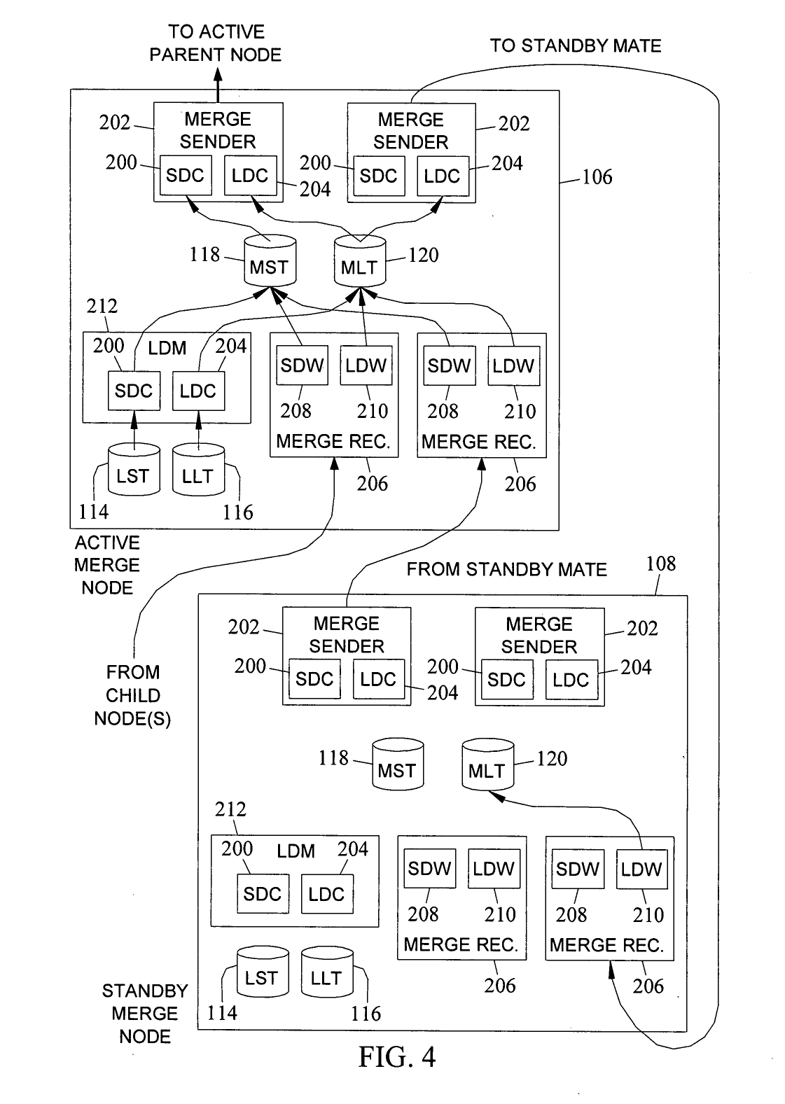

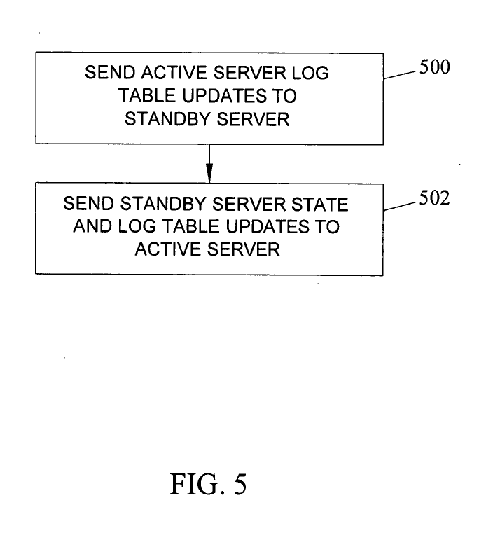

FIG. 4 is a schematic diagram of active and standby servers 106 and 108 configured for data merging in accordance with the subject matter described herein. Active and standby servers 106 and 108 are a B level mated pair of servers. FIG. 5 is a flow chart of an exemplary data merging process interaction between active and standby servers 106 and 108 shown in FIG. 4 according to an embodiment of the subject matter described herein. Referring to FIGS. 4 and 5, active server 106 may send log table updates to standby server 108 (block 500). For example, one of merge sender functions 202 residing on active server 106 may establish a link to one of merge receiver functions 206 residing on the standby server 108. For this step, the sending merge sender function 202 activates its log data collector 204, while stateful data collector 200 remains inactive. All updates written to merge log tables 120 are forwarded by other receivers to standby server 108 as required. This instance of the merge sender function 202 is separate from the merge sender function connected to the active parent server, so both links maintain their own table cursors and forward updates independently.

In block 502, standby server 108 may send state and log table updates to active server 106. For example, one of merge sender functions 202 residing on standby server 108 may communicate state and log table updates to one of merge receiver functions 206 residing on active server 106. The sending merge sender function 204 on standby server 108 may directly monitor local state and log tables 114 and 116 for updates on standby server 108 and forward messages to active server 106 to be merged in with other servers sending updates. Local database merge function 212 may not be involved in this case because it would violate the model to write any log updates directly into the local merge log tables without first going through the active server.

These two steps of blocks 500 and 502 may each use a separate, dedicated connection to implement their protocol semantics. While this is not strictly necessary, it may be more practical to reuse existing object implementations. Certain other components present in the standby server and not mentioned with reference to blocks 500 and 502 (i.e. merge receiver functions from child servers, merge sender to the parent server, and local database merge function of the standby server) may remain in a dormant state until after a failover event occurs.

In order to accurately detect database changes to state and log tables, an initial state may be established for these tables. For state tables, the entire table contents may be duplicated in memory so that changes to individual rows can easily be identified. For log tables, which can only add new records to the end of a table, a cursor is used to keep track of the current record which has been sent to the parent. The initial state of each table is established during a database audit which occurs as part of the sequence of events triggered by a registration (i.e., when a connection is first established) or a failover between a mated pair of servers. An audit may consist of an exchange of messages between a parent server and its child to synchronize the databases of both servers so that only database updates need to be sent during normal operation.

For auditing state tables, the entire table contents of each table are transmitted to the parent server. The parent server clears all table entries originating from that server and populates the tables with the contents received during the audit. The child server may also maintain its own copy in its database and uses this to detect updates to the tables.

For auditing log tables, the parent first transmits the last record in each table to the child server. The child server may use timestamp information contained in the message to locate the position in each local log table. Further, the child server may then establish the cursor for that table, which now accurately reflects the last record that the parent server has received. If the parent server has no records from a given log table, the child server will set the cursor to the first record of that table. If the exact record cannot be found in the table, the audit mechanism may use the timestamp information to choose a nearby record.

During normal program operation, it is possible that a parent server and child server could become out-of-sync with each other. This condition may be detected when the parent tries to apply an update message received from the child server for a stateful table, but that update is unsuccessful. For example, an update which tries to delete a record which does not exist would be detected as a failure condition. In this case, the parent server may request that the stateful tables be audited again to regain the synchronized database state. The child server can be configured to honor the request by transmitting all table contents in the same manner as described in the post-registration audit.

Audits of log tables can span multiple tiers of the topology since servers at the top level are receiving updates (indirectly) from servers which are two levels down in the hierarchy. This means that an A level server can request an audit of stateful tables from a C level server, and the audit will refresh the merge tables at both A level and B level servers with the current table contents.

Data merging in accordance with the subject matter described herein can attempt to achieve fairness when collecting records from multiple log tables in a database. The objective of collection fairness is to ensure that some tables do not get “starved out” when another table has more records to collect. To understand the question of fairness, consider one log table that is adding 1000 records per second and a second table that is adding 1 record per second. The simplest (but potentially unfair) algorithm would be to scan the first table until all records have been collected, and then move to the second table. If the scanning operation took place at a frequency of once every 10 seconds, this routine would have to collect 10,000 records from the first table before the checking the second table for its 10 records. If the system was under heavy load, the second table may get starved for quite some time. Ideally, a perfectly fair algorithm would collect all records in timestamp order, regardless of which table they are in. In that case, 1000 records would be sent from table 1, then 1 record from table 2, then the next 1000 records from table 1, etc.

Ideally, a mechanism for achieving collection fairness will quickly determine which table has oldest records waiting for collection and choose an appropriate limit on the number of records collected from a single table before checking whether some other table has older records than current table cursor. The following exemplary techniques may be used to achieve fairness in the data merging processes in accordance with the subject matter described herein:
1. Heap Algorithm—A heap algorithm sorts the cursors for each table in descending order. This allows the collection process to quickly determine which table has oldest records waiting to be collected.
2. MaxLogDelta parameter—This configurable parameter defines the maximum number of records to collect from a single table before checking the heap for other tables with potentially older records. By default, up to 100 rows will be collected from a single table before scanning other tables.
3. Table Priority classification—A log table may be designated as either “high priority” or “normal priority”. During the collection process, all high priority tables are collected first. Once all high priority table records have been exhausted, normal priority tables will then be collected. This is implemented using two separate heaps: one for high priority tables, and the other for low priority tables.

One concern with deploying data merging in a large network includes the risk of overwhelming administrative servers with updates originating from many servers. This problem is unique to data merging because a large number of servers in the network can autonomously choose to send database updates at any time to the administrative systems, which have no prior knowledge of when these updates are coming. This is in contrast to database replication between a single master and many slaves, in which the master has complete control over its workload in sending database updates to its slaves. In the context of data merging, the administrative servers may need some other mechanism to control the flow of incoming updates from many servers in a network. This is the motivation for a top-down throttling technique.

The objective of the throttling technique is to establish a maximum rate of incoming data to a merging server and allocate this bandwidth fairly among child servers of a server. From a high level, one exemplary technique of throttling that may be used includes:
1. Receivers measure the amount of data received from each server (in bytes per second);
2. The local database merge function computes the aggregate incoming data rate;
3. If the incoming data rate is below a minimum throttle rate parameter (e.g. 70% of the allowed maximum rate), all senders are allocated the full rate; and
4. If the incoming rate is above the minimum throttle rate parameter, the local database merge function divides the available bandwidth among all sender servers. The amount allocated to each server may depend on several factors. Exemplary factors include the following:
   a. The exact incoming rate percentage between 70%-100% of the maximum allowed rate;
   b. The fraction of bandwidth used by that sender compared to the total incoming rate; and
   c. How far behind that sender is with relation to other senders. (The amount that a sender is behind is a measure of how old are the oldest Log table updates waiting to be sent with respect to the current time).
      The resulting maximum allowed sending rate is transmitted to each server using the messaging protocol. Each sender may keep track of its allowed send rate and its actual send rate and may determine whether sending the next message would exceed the allowed send rate. If so, it queues the message and waits a sufficient length of time until the message can be sent without violating the allowed send rate.

The throttling technique described above may also consider multi-tiered networks. For example, in a three-tier network topology, the top-most A level server must receive all updates from all servers in the network. Therefore, the top-most server is a limiting factor for the effective maximum data rate. It allocates bandwidth to its child B level servers, and that bandwidth allocation becomes the new limit from which that B level server may allocate to its child C level servers. Thus, the C level servers may be indirectly limited by the A Level server as the total incoming data rate approaches the established limit on the A level server.

According to one embodiment, a merge table may be defined in several requirements. For example, a merge table may include two subparts: (1) one subpart (referenced herein as subpart 0) may be used by applications to store records locally; and (2) another subpart (referenced herein as subpart 1) may be used by a merge process to store records received from this server, its mate server (i.e., standby server), and its children.

Exemplary software code for a merge table definition may include a field “$INT16 part” to track of the subpart number (0 or 1). This field will implicitly become part of the primary table key, so it should not be explicitly included in the key definition.

A merge table definition may also include a field “$NODEID source” as the first field of the primary table key. This field will be used to indicate which source server originally created each record present in the merge table (sub-part 1). This field is populated automatically by the merge process, therefore it is not necessary for applications to populate it in sub-part 0. Applications may set this field to null in sub-part 0.

An exemplary application of the subject matter described herein is signaling network link monitoring. For example, data may be collected with regard to link status. The link status information may be collected at low level servers in a network topology. This information may be provided to higher level servers, such as administrative servers, by systems and methods disclosed herein. An exemplary merge table structure for use in link monitoring is set forth below:

```
$table NodeRun MergePart
  bool isDown( ) const { return ::isDown(state); }
  bool isConnected( ) const { return ::isConnected(state); }
  // Merge table stuff
  $INT16  part  // 0=local, 1=remote
  $NODEID  source  // local server ID (needed for merge tables)
  $NV8(NodeRunApp)  app  // app providing status
  $NODEID  nodeId  // remote Server ID
  $NV8(NodeRunDir)  dir  // direction (to/from)
  $NV8(NodeRunState)  state  // connection state
  $INT32  deltaSeq  // delta of sequence number (how far behind)
  $INT32  deltaTime  // delta of time (how far behind)
  $TIME32  updateTime // last update time
      $fmt Time
  $STRING(NodeRunInfoLen) info  // informational string
      $wid 30
  $tblPartFld  part
  $tblNetSync  MS  // Merge-type: Stateful data
  $key(Btree) nodeApp : source app nodeId dir
$end table
```

The following is a description of the fields of the above exemplary merge table structure:
source—NodeRun is the title of the merge table. Since NodeRun is itself a merge table, the source field is be populated with the Server ID of the host on which a given record originated.
app—This field identifies the application providing status.
nodeld—This field identifies remote Server ID to which this link is connecting.
dir—This field describes the direction of control for the link (to/from). The value “to” indicates that the remote server is a slave (or subscriber) with respect to the local server. In general, database updates generated locally will be flowing from the local database to the remote server over the link in question. The value “from” indicates that the remote server is a master (or publisher) with respect to the local server. In general, database updates will be sent from the remote server to the local database over this link. It is noted that to/from does not correlate to TCP client/server.
state—This field indicates the current link state, which are set forth below:
   Down—The link is down and there is no current attempt to restore it.
   DownListening—The incoming link is down awaiting the other side to initiate the connect attempt.
   DownConnecting—The link is down but this side is trying to connect.
   DownRejected (Transitory)—The link is down because a connect attempt was rejected in the “handshake” phase. There are three possible reasons for this:
      Node Conflict—The remote server thinks it already has a connection from the local Server ID.
      Invalid Parent—The remote server's level (A, B, C) is higher than the local server's level, making the local server an invalid parent. This points to an invalid parent association.
      Invalid Mate—The remote server is on the same level as the local server, but is not in the same cluster, or is not a valid mate (only the first 2 servers in the cluster can be mates).
   DownHandshake—The link is connected but not ready for application use (so it is “down” logically).
   Connected—Connected and ready for use.
   ConnectedReinit—Connected and ready for use, but after an application error where the recovery is “start over” without either a link drop or a complete application restart.
   RegisterSent (Transitory)—Indicates the link is exchanging application level credentials and information (such as data dictionary information). In this state, registration has been sent from one side and it is being awaited from the other side.
   RegisterAcked (Usually Transitory)—Indicates that registration has been sent acknowledged from the other side. In most configurations, it is a transitory state, but the end application can hold the link in this state before permitting an “audit”.
   Standby—Standby means the high-availability state is standby, but the applications have exchanged registration messages.
   Inhibited—Inhibited means the link administrative state is inhibited (or disabled), but the applications have exchanged registration messages.
   Audit—Audit means the application is bringing the databases into agreement. It does so by comparing each table one-by-one, and then applying database updates since the audit began.
   Active—Active means the link is in the “normal” active steady-state conditions where updates are being transferred to the slave database(s) with a normal and acceptable delay.
   ActiveBehind—ActiveBehind is the same as “Active” but the slave database is unacceptably behind for whatever reasons. After an audit, it would be typical to be in the ActiveBehind state until any queued updates are applied to the slave database.
deltaSeq—This is a delta indicating how far behind the slave sequence number is compared to the master
deltaTime—This is a delta indicating how many seconds behind the slave is compared to the master
updateTime—This value indicates the last update time of the NodeRun record. This should be continuously updating for active and standby links.
info—This is a string value providing extra information about the current link state.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for accessing data associated with a plurality of similarly structured distributed databases, the method comprising:
receiving from a first distributed database a first value of a data element associated with the first distributed database;
receiving from a second distributed database a second value of the data element associated with the second distributed database;
including the first and second values of the data element in a third merged database; and
accessing the first and second values of the data element in the third merged database.

2. The method of claim 1 wherein the first distributed database is located at a lower network topology level than the third merged database.

3. The method of claim 1 wherein receiving from a first distributed database includes receiving from the first distributed database a first source identifier associated with the first distributed database, and wherein receiving from the second distributed database includes receiving from the second distributed database a second source identifier associated with the second distributed database.

4. The method of claim 3 comprising including the first and second source identifiers in the third merged database, and wherein the method further comprises associating the first and second source identifiers with the first and second values, respectively, in the third merged database.

5. The method of claim 1 wherein receiving from a first distributed database includes receiving from the first distributed database a first stateful value, and wherein receiving from the second distributed database includes receiving from a second distributed database a second stateful value.

6. The method of claim 1 wherein receiving from a first distributed database includes receiving from the first distributed database a first log value, and wherein receiving from the second distributed database includes receiving from the second distributed database a second log value.

7. The method of claim 6 wherein receiving from the first distributed database a first log value includes receiving a first timestamp value associated with the first log value, and wherein receiving from the first distributed database a second log value includes receiving a second timestamp value associated with the second log value.

8. The method of claim 7 comprising including the first and second timestamp values in the third merged database, and wherein the method further comprises associating the first and second timestamp values with the first and second values, respectively.

9. The method of claim 1 wherein receiving from a second distributed database includes receiving from the second distributed database located at a lower network topology level than the third merged database.

10. The method of claim 1 comprising updating a standby database with at least one of the first value and the second value of the data element in the third merged database.

11. The method of claim 10 wherein updating a standby database comprises updating the standby database with a log value of the data element in the third merged database.

12. The method of claim 1 comprising updating the third merged database with at least one of a state value and a log value of the data element from a standby database.

13. The method of claim 1 comprising designating the first and second values of the data element in the third merged database as read-only data.

14. The method of claim 1 comprising collecting values from the first and second distributed databases in accordance with a data collection fairness process.

15. The method of claim 1 comprising collecting values from the first and second distributed databases in accordance with a throttling process.

16. The method of claim 1 wherein the first and second distributed databases are at a lower level in a network topology than the third merged database.

17. A system for maintaining and accessing data associated with a plurality of similarly structured, distributed databases, the system comprising:
first and second distributed databases and a third merged database;
a merge receiver function configured to receive first and second values of a data element from the first and second distributed databases, respectively, and configured to include the first and second values of the data element in the third merged database; and
wherein the third merged database is adapted to receive the first and second values of the data element, and wherein the third merged database is adapted to store and provide access to the first and second values of the data element.

18. The system of claim 17 wherein the first distributed database is part of a lower network topology level than the third merged database.

19. The system of claim 17 wherein the merge receiver function is configured to receive from the first distributed database a first source identifier associated with the first distributed database and wherein the merge receiver function is configured to receive from the second distributed database a second source identifier associated with the second distributed database.

20. The system of claim 19 wherein the merge receiver function is configured to include the first and second source identifiers in the third merged database, and wherein the merge receiver function is configured to associate the first and second source identifiers with the first and second values, respectively.

21. The system of claim 17 wherein the merge receiver function is configured to receive from the first and distributed databases first and second stateful values, respectively.

22. The system of claim 17 wherein the merge receiver function is configured to receive from the first and distributed databases first and second log values, respectively.

23. The system of claim 22 wherein the merge receiver function is configured to receive a first timestamp value associated with the first log value, and wherein the merge receiver function is configured to receive a second timestamp value associated with the second log value.

24. The system of claim 23 wherein the merge receiver function is configured to include the first and second timestamp values in the third merged database, and wherein the merge receiver function is configured to associate the first and second timestamp values with the first and second values, respectively.

25. The system of claim 17 wherein the merge receiver function is configured to receive the second value from the second distributed database located at a lower network topology level than the third merged database.

26. The system of claim 17 comprising a merge sender function configured to update a standby database with at least one of the first value and the second value of the data element in the third merged database.

27. The system of claim 26 wherein the merge sender function is configured to update the standby database with a log value of the data element in the third merged database.

28. The system of claim 17 wherein the merge receiver function is configured to update the third merged database with at least one of a state value and a log value of the data element from a standby database.

29. The system of claim 17 wherein the merge receiver function is configured to designate the first and second values of the data element in the third merged database as read-only data.

30. The system of claim 17 wherein the merge receiver function is configured to collect values from the first and second distributed databases in accordance with a data collection fairness process.

31. The system of claim 17 wherein the merge receiver function is configured to collect values from the first and second distributed databases in accordance with a throttling process.

32. The system of claim 17 wherein the first and second distributed databases are at a lower level in a network topology than the third merged database.

33. A computer program product comprising computer executable instructions embodied in a computer readable medium for performing steps comprising:
receiving from a first distributed database a first value of a data element associated with the first distributed database;
receiving from a second distributed database a second value of the data element associated with the second distributed database;
including the first and second values of the data element in a third merged database; and
accessing the first and second values of the data element in the third merged database.
